(19) United States
(12) Patent Application Publication
(10) Pub. No.: US 2014/0279384 A1
(43) Pub. Date: Sep. 18, 2014

(54) MONITORING FINANCIAL RISKS USING A QUANTITY LEDGER

(71) Applicant: Reinhold Loevenich, Sandhausen (DE)

(72) Inventor: Reinhold Loevenich, Sandhausen (DE)

(73) Assignee: SAP AG, Walldorf (DE)

(21) Appl. No.: 13/835,994

(22) Filed: Mar. 15, 2013

(51) Int. Cl. G06Q 40/02

(52) U.S. Cl. CPC G06Q 40/025
USPC 705/38

(57) ABSTRACT

The present disclosure describes methods, systems, and computer program products for monitoring financial risks using a quantity ledger. One computer-implemented method includes receiving a contract, wherein the contract includes at least one transaction, parsing the contact to identify the at least one transaction, deriving, by operation of a computer, at least one associated future transaction for the at least one transaction, logging the derived at least one associated future transaction to a quantity ledger, aggregating, by operation of a computer, the logged quantity ledger data to determine the presence of an exposure, and applying at least one rule to determine if an exposure mitigating action should be performed based upon the aggregated logged quantity ledger data.

### BACKGROUND

Regulatory and legal requirements necessitate that organizations monitor, analyze, and report financial risks, or exposures, as part of financial risk management. These requirements are designed to ensure that an organization manages its exposure to financial risk in order to, for example, protect financial markets, protect investors, and enhance the economic value of the organization. Examples of financial risks include exposures of the organization to foreign exchange rates, varying market prices of goods/services sold or purchased, inflation, uncertain liquidity, interest rate changes, or a combination. For many organizations, monitoring such risks is not only a regulatory obligation, but, more importantly, a key to running the organization successfully. For example, ensuring at least financial liquidity may help ensure the survival of the organization. At present the monitoring, analysis, and reporting of financial risk often requires specialized training/personnel; different software tools, data models, and algorithms for varying financial risks or industries; and adherence to complex and expensive regulatory requirements. Disparate tools and underlying data models make it very difficult to get a holistic picture of the organization's short-to-midterm future and are often not integrated into software systems dealing with actual data, in particular with financials software. As such, consistent simulations of future scenarios are very difficult to achieve.

### SUMMARY

The present disclosure relates to computer-implemented methods, computer-readable media, and computer systems for monitoring financial risks using a quantity ledger. One computer-implemented method includes receiving a contract, wherein the contract includes at least one transaction, parsing the contact to identify the at least one transaction, deriving, by operation of a computer, at least one associated future transaction for the at least one transaction, logging the derived at least one associated future transaction to a quantity ledger, aggregating, by operation of a computer, the logged quantity ledger data to determine the presence of an exposure, and applying at least one rule to determine if an exposure mitigating action should be performed based upon the aggregated logged quantity ledger data.

Other implementations of this aspect include corresponding computer systems, apparatuses, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination:

A first aspect, combinable with the general implementation, wherein the at least one associated future transaction is derived in parallel for two or more identified transactions.

A second aspect, combinable with any of the previous aspects, wherein the logged data is stored in the quantity ledger as at least one quantity flow.

A third aspect, combinable with any of the previous aspects, wherein the quantity ledger is divided into at least one quantity position, each quantity position representing a set of selection criteria associated with a valuation purpose for at least one quantity flow.

A fourth aspect, combinable with any of the previous aspects, wherein an exposure is defined as a quantity flow with a contract value deviating from an internal value.

A fifth aspect, combinable with any of the previous aspects, further comprising selecting flows in the quantity ledger based upon at least one quantity position.

A sixth aspect, combinable with any of the previous aspects, wherein aggregated quantity flows must balance to zero.

The subject matter described in this specification can be implemented in particular implementations so as to realize one or more of the following advantages. First, exposures are not considered as time dependent objects, for which a lifecycle is traced. Instead exposures are considered similarly to balances of bank accounts. In some implementations, software records the changes to an exposure similar to recording withdrawals and deposits of a bank account. Therefore, the balance/exposure can be considered simply an accumulation of the recorded changes. A time dependency or lifecycle is equivalent to a calculation of balances for different key dates. Second, changes in balances due to business transaction are recorded similarly to journal entries in General Ledger Accounting. In particular a journal entry refers to a point in time and not to a period in time. This approach simplifies and normalizes a data model allowing simplified and comprehensive evaluations of the data. Third, as journal entries must balance to zero, a crosscheck can be performed to ensure that the journal entries represent all necessary changes to the account. An analogy to accounting means that any change of an exposure—or more neutrally expressed—any change in a quantity implies a connected change of another quantity. Fourth, software has intrinsic logic to interpret contractual information associated with journal entries or referenced in the journal entries in such a way that further journal entries are expected or committed to happen in the future. Therefore, the quantity ledger contains both past and future data expressed in the same manner. For example, future data comprises rather deterministic transactions like the interest payment of a well-rated country's government bond as well as the chain of expected deliveries, invoices and payments resulting from a sales order. Fifth, part of software interpreting contractual information can easily be adjusted to conform to specific requirements of a user and can also be used to integrate budgeted and/or planned data, thus improving the precision and reach of a forecasted future. Sixth, the quantity ledger separates contractual data from values and retains the contractual data only. Assigning values to the contractually agreed calculation basis, which is the quantity, is performed during evaluation of the data, allowing consideration of recent market data or special valuation procedures. Seventh, the similarity of the data model to the one associated with a general ledger allows people familiar with accounting but not necessarily with risk management to understand and evaluate information. Additionally, forecasts for balance sheets, income statements and other financial reports are possible with little effort. Other advantages will be apparent to those skilled in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1A is a block diagram illustrating an example distributed computing system for monitoring financial risks using a quantity ledger according to one implementation.

FIG. 1B is a block diagram illustrating additional components of a server for monitoring financial risks using a quantity ledger according to one implementation.

FIGS. 2A-2F illustrate journal entries in a quantity ledger resulting from the creation of a sales order according to one implementation.

FIGS. 3A-3F illustrate journal entries in a quantity ledger resulting from the creation of a purchase order according to one implementation.

FIGS. 4A-4D illustrate journal entries in a quantity ledger resulting from the purchase of a future according to one implementation.

FIGS. 5A-5B illustrate external data according to one implementation.

FIG. 6 is a flow chart illustrating a method for monitoring financial risks using a quantity ledger according to one implementation.

Like reference numbers and designations in the various drawings indicate like elements.

### DETAILED DESCRIPTION

This disclosure generally describes computer-implemented methods, computer-program products, and systems for monitoring financial risks using a quantity ledger. Software capable of forecasting a financial future in a uniform and comprehensive manner on the basis of committed contracts, as well as planned or budgeted financial data, would be of great benefit to an organization and provide an important competitive advantage.

The following description is presented to enable any person skilled in the art to make and use the invention, and is provided in the context of a particular application and its requirements. By combining principles of general ledger accounting and concepts common in valuating financial instruments, an example distributed computing system can analyze, monitor, and/or simulate multiple financial risks in a holistic manner using a typically complete data pool called a quantity ledger and various algorithms to read, write, and analyze the quantity ledger. Various modifications to the disclosed implementations will be readily apparent to those skilled in the art, and the general principles defined herein may be applied to other embodiments and applications without departing from scope of the disclosure. Thus, the present disclosure is not intended to be limited to the described and/or illustrated implementations, but is to be accorded the widest scope consistent with the principles and features disclosed herein.

Exposures are risks stretching over a period of time into the future and are subject to changes since they refer to future (possibly changeable) events as measured from a start date. For example, for a deliverable software system, a price exposure is an object characterized by a quantity for which a price varies and the due date, and when the exposure disappears, that is when the date when the price is fixed. The price exposure might have an explicit start date or implicitly use a system time stamp for when data was entered as the start date. In summary, the price exposure is an object represented in deliverable software system referring to a period of time and a quantity.

Different types of exposures may be measured in different units and may also be mixed with a valuation of the exposure, meaning attributing a monetary/other value to the exposure. For example a cocoa consumer measures the exposure to cocoa prices in amount (t) of cocoa. Such a consumer takes as a given that at least two financial risks associated with amount t of cocoa may include changing market prices, which influence the production cost, and foreign exchange rate fluctuations. Ideally the consumer would like to assign a monetary value to the exposure, in this case typically mark-to-market—the difference between the agreed contract price and the market price. Liquidity is a different kind of exposure, because although it is typically measured in monetary units immediately, an additional tool is needed to track how much cash or cash equivalents the consumer will possess on every day of the liquidity reporting period. Even more complex are exposures associated with interest rate changes affecting loans that the consumer might have taken. In this case the net present value of the outstanding loan can be considered an exposure.

In current practice, financial risks appear to be of different natures and without a possible common data model to represent the various financial risks. However, in practice it can be seen that various financial risks are highly interdependent. Consider, for example, foreign exchange (FX) risks. An organization may trade commodities in the most important foreign currencies different from a local/functional currency and might want to mitigate this risk before even contracts like sales orders are realized. In this instance, there is an implicit dependency on foreign exchange rates as well as liquidity. Foreign exchange rates can value/devalue the local/functional currency and monetary liquidity can be affected as the organization may wish to not exchange currency at a given time due to adverse exchange rates, resulting in currency being unavailable for use. Additionally, as a due date approaches, an organization's sales orders need to be balanced against forecasted exposures. At some later point-in-time, the sales orders get invoiced and a character of the exposure changes again. The process might even be extended until a bank statement comes in.

The above-described difficulties disappear with a change of perspective related to exposures. The primary changes include:

Consider Exposures as Positions,

Record Business Transactions,

Record Only Contractual Information,

Forecast Business Transactions Based on Contracts and Conditions,

Attribute Values to Positions, and

Identifying Exposures.

Consider Exposures as Positions

Instead of “exposures,” consider measuring quantities—quantities of goods to deliver, already delivered or other “kinds” of quantities that potentially change over time. It is important to state the key date at which the measurement took place. If measurements of a changing quantity are made regularly, a time series is generated which can be either considered as different “versions” of the measured object or understood as a time dependent result of changes happening to that object. For example, for bank account, the balance can be understood as different states of the bank account or as the accumulated result of changes to the bank account—the withdrawals and deposits. It is also common to “forecast” balances in the case one has issued checks which have not yet been cashed. Positions are therefore objects having a time-dependent balance, such as a bank account.

Exposures can be considered to be positions. In a balance sheet, companies show cash alongside with receivables. The receivables are basically “expected cash”. In a position perspective, cash is the position representing money “on stock” and receivables are the position of “money my customer is obligated to pay.” Therefore, a position can be a position of obligations, a position of stock, or even a position of rights. Ultimately, even planning data can be treated in this way. Since many exposures refer to events in the future, the exposures often are positions of obligations. As the example of receivables and cash shows, over time positions of obligations often become stock positions (received money becomes “on stock”). This corresponds to the life cycle of an exposure in a common perspective. When considering exposures to be positions, an exposure is a transfer from one position to another one.

Record Business Transactions

Again considering the example of the bank account. While the most important information related to a bank account can normally be considered the account balance, it is clear that the latest account balance can only be understood by accumulating changes since a last account balance. This is true as well the general rule in General Ledger Accounting.

In some implementations, the described system records journal entries in a quantity ledger (described below). The journal entries are representations of business transactions in the real world and record changes to accounts—not versions of account balances. A business transaction is considered an event at one point in time and does not stretch over a period of time. As the focus is on single points in time, this approach allows the system to easily keep track of relevant information. Time dependencies become visible when looking at a particular account, i.e., position, over a period of time that displays account balances at different key dates.

Additionally, as in accounting, journal entries have to balance to 0, i.e., the amounts credited need to equal those debited. This “balance zero principle” provides a crosscheck as to whether the journal entry represents all the changes due to the represented business transaction.

Changes in generalized quantities are recorded as “quantity business transactions” (QBTs). A QBT refers to a point in time. “Items” of the transaction are referred to as “quantity flows” or “flows.” For example, the creation of a sales order with one order item is represented as a transaction with two flows, one representing the obligation to deliver goods and one representing a committed receivable. Quantity can be considered to be “generalized” because the obligation of the goods delivery is measured in physical quantity units while the committed receivable is in monetary units, different units between each obligation, etc. Therefore, it makes sense to consider “payment” amounts as a quantity in the sense that these are contractually agreed exchanged “goods” (i.e., money of some type). Also, an amount does not necessarily represent a value. For example, for a loan given to a bankrupt party, while the nominal amount of outstanding debt is measured in monetary units, the value is very different because one cannot expect to get all the money back.

Record Only Contractual Information

Business transactions record changes in quantities of stock as well as quantities of obligations or rights to deliver or receive goods—an aspect of quantity can be referred to as a “flavor.” Furthermore, contractually agreed payment amounts are considered to be quantities. In a situation where a payment amount is not known at the time a business transaction is entered or created in the system, for example because the order states that the price will be determined as an average of market prices at a future point in time, the system stores the contract price determination rule and all its calculation basis.

Quantity business transactions represent the quantity and contract information only and do not typically store values in the sense of what a particular flow is worth. In some implementations, an exception from this rule applies to “internal” business transactions, such as actual delivery of an ordered good. The delivery of the ordered good contains one flow offsetting the obligation to deliver and another flow decreasing the inventory for the good.

The balance zero principle for quantity business transactions means that the contractual value, even if only know by calculation rules, must balance. This rule helps to make sure that no quantity flavor is forgotten. In other words, quantity business transactions are precursors to journal entries.

Forecast Business Transactions Based on Contracts and Conditions

Future events, e.g., due dates, are also represented as quantity business transactions although future dates are subject to changes. Such changes are allowed to these types of transactions by associating the transaction with a life cycle status. For example, the transaction can be associated with a status of “planned,” “fixed,” “reversed,” and/or other suitable status value. As long as a transaction has an associated future date, it can be changed. However, at some point in time, the date of the transaction becomes past which “fixes” the transaction and prevents any further changes.

All aspects/conditions/obligations of a particular business transaction must be analyzed and determined. For example, when a sales order is created, the system will create not only the described business transaction (the sales order), but any associated future transactions. Associated future transactions may include, for example, a scheduled delivery as well as invoicing, or other suitable transaction. In the example of a sales order, the associated future transactions offset obligation flows and in turn affect the goods inventory as well as the sales receivables. As an obligation is a firm commitment by one of two or more contracted parties to deliver something (e.g., goods or cash) in the future, at least this future event must be available in the system for analysis. A transaction forecast engine (TFE) (described below) is used to analyze and interpret properly conditions associated with a particular business transaction. In some implementations, multiple TFEs can operate within the system. Each of the TFEs focuses on successor transactions to a particular “original” transaction. For example, a sales order TFE can create expected deliveries as well as scheduled price fixings and invoicing. Similarly, an invoice forecaster could then react to the planned invoice and create planned receivables, possibly even planned confirmations of payments using bank statements. TFEs also permit simulations of future states as transactions are generated in response to an assumed change. Data values associated with future transactions can be modified to see how they affect the overall system and financial risks. Since applicable data can contain information on which quantities are priced and in which way, the applicable data is a natural foundation for simulations. For example, dependencies on market price changes (both FX and material) can easily be tested. Additionally, “what-if-simulations” (e.g., what is the effect of additional sales orders) are possible if TFEs are good enough. Given accounting similarities, forecasts of financial statements can also be performed using the described concepts.

Attribute Values to Positions

Time-dependent values can also be assigned to flows, for example a contract value and an internal value. A contract can specify both an explicit value for a flow as well as simply a rule how to calculate the value, typically referencing some market data, for example commodity prices of an exchange. As long as the commodity prices are not clear (fixed), they need to be forecasted based on currently available information, for example market exchange rates and the market price for a good. Because the information changes independently of the contract, in some implementations, the currently available information is stored independently (e.g., not in the same database, data structure, etc.) of the contract and associated flows. In other implementations, a flow's storage location may store and/or reference the currently available information.

In general, a quantity has a value only with respect to some key date, or what is considered a date of evaluation. Although there are many situations in which a contract value does not change over time, it will still be considered to be dependent on the date of evaluation.

Aside from a contract value, each flow can also have a different “internal” value from the perspective of a user looking at the data. For example, a purchasing company buys oil at variable prices and uses the oil for its production. The oil is then an expense and most likely priced into the purchasing company's production cost at some assumed fixed price (an “internal” value). It is reasonable to assign this fixed price to the oil—and to try to actually buy cheaper. The internal value can also depend on the purpose for which the data is to be used. In the previous example, the purchasing company might want to see the budgeted fixed value while an accountant might want to look at the same data and wants the system to use a weighted average, actual price, or even different values for different accounting principles.

Determining an internal value, or any associated value by way of conversion, can be performed by any available procedure, both commercial and proprietary. In some implementations, procedures might be different for different flows. A quantity position therefore defines a set of selection criteria for flows. The valuation procedure for the flows is then assigned to these positions. To support different valuation purposes a “valuation purpose” attribute should be associated to each position similar to a valuation area, accounting principle, or set of books in common accounting practice.

Values of flows of obligation, receivables, and “non-stock” flows are the values of future flows, not past flows. For example, if the system is to determine the value (contract or internal) of a position as of a key date, it then aggregates from the key date into the future and not from the beginning of the system to the key date. As an exception, only for “stock-like” positions it is reasonable to aggregate the past. For example, a projection of future liquidity is obviously one way to evaluate flows involving cash. Assuming the user wants to see the total available cash over the coming two weeks, the system has to aggregate flows from the past until each day (this is a kind of “quantity” reporting, so aggregation of the past is applicable). Regarding the sign of these values it is convenient to invert the sign of any value in the future with respect to the sign of the quantity change.

Identifying Exposures

Flows with a contract value deviating from the internal value are potentially risky but can be compensated for by other flows. A position is an exposure, if the aggregated contract value differs from the aggregated internal value at any time in the future. A generic algorithm can be used to make the determination whether a quantity position, independent of risk type. Furthermore, the same algorithm and database, for example a conventional and/or in-memory database, can be used to monitor any risk types. In the case that contract or internal values are requested, the task can become more complex, since possibly non-trivial operations have to be performed on a large amount of data. Typically these values do not need to be updated more than once daily. Therefore, in some implementations, the values could be calculated and cached in a separate database table for future use. The more future transactions that are recorded and the more precise the TFE, the more applicable, accurate, and useful the described system becomes.

Example uses can include cash and liquidity forecast, foreign exchange exposure monitors, commodity exposure monitors,

FIG. 1A is a block diagram illustrating an example distributed computing system 100 for monitoring financial risks using a quantity ledger according to one implementation. The illustrated example distributed computing system 100 includes or is communicably coupled with a server 102, a client 140, and an external data source 150 that communicate across a network 130 (described below). At a high level, the server 102 is an electronic computing device operable to receive, transmit, process, store, or manage data and information associated with the example distributed computing system 100. According to some implementations, server 102 may also include or be communicably coupled with an e-mail server, a web server, a caching server, a streaming data server, and/or other suitable server. The following described computer-implemented methods, computer-readable media, computer systems, and components of the example distributed computer system 100 provide functionality through one or more graphical user interfaces (GUIs) providing an efficient and user-friendly presentation of data provided by or communicated within the example distributed computing system 100.

The external data 150 may contain any suitable data in any suitable format consistent with the disclosure to permit at least logging of journal entries into a quantity ledger, forecasting of associated business transactions based upon a first business transaction, and/or determination whether an exposure exists based upon quantity data and/or a quantity ledger. For example, as illustrated in FIGS. 5A-5B, the external data 150 can contain exchange rate data (FIG. 5A) and commodity market data (FIG. 5B) which can be used for the previously describe purposes. This example external data 150 can, in some implementations, be stored in/retrieved from a database, flat file, RSS feed, spreadsheet, and the like. In some implementations, the external data 150 can be requested and/or provided real-time data. In some implementations, the external data 150 can provide references/links to additional external data sources 150 (not illustrated), such as in a cloud-computing environment.

In general, the server 102 is a server that stores one or more business applications 110, where at least a portion of the business applications 107 are executed using requests and responses sent by clients 140 within and communicably coupled to the illustrated example distributed computing system 100. In some implementations, the server 102 may store a plurality of various business applications 107. In other implementations, the server 102 may be a dedicated server meant to store and execute only a single business application 107. In some implementations, the server 102 may comprise a web server, where the business applications 107 represent one or more web-based applications accessed and executed by the client 140 using the network 130 or directly at the server 102 to perform the programmed tasks or operations of the business application 107. In some implementations, the server 102 allows a user to access process definition (not illustrated) and/or process instance data (not illustrated) about business processes associated with and executing in conjunction with a particular business application 107.

The server 102 is responsible for receiving requests using the network 130, for example login requests, software selection, configuration, and/or purchase requests from one or more client applications 146 (described below) associated with the client 140 of the example distributed computing system 100 and responding to the received requests by processing said requests in one or more of a business application 107, journal entry engine (JEE) 108, transaction forecaster 109, and/or exposure monitor engine (EME) 110. In addition to requests from the client 140, requests may also be sent to the server 102 from internal users, external or third-parties, other automated applications, as well as any other appropriate entities, individuals, systems, or computers.

In some implementations, the business application 107, JEE 108, transaction forecaster 109, and/or EME 110 can provide GUI interfaces or interface with one or more other components of the example distributed computing system 100 to provide GUI interfaces to assist users to monitor financial risks using a quantity ledger. For example, a request to monitor a sales order entered in the business application 107 could be issued by a user that when processed by the JEE 108, transaction forecast engine 109, and/or EME 110 using data obtained from the external data source 150 can result in a returned HTML or other formatted document renderable by a client application, for example a web browser, to provide determined financial risk data for the sales order to the user.

In some implementations, requests/responses can be sent directly to server 102 and/or external data 150 from a user accessing server 102 directly. In some implementations, the server 102 may comprise a web server, where one or more of the components of server 102 represent web-based applications accessed and executed by the client 140 using the network 130 or directly at the server 102 to perform the programmed tasks or operations of the various components of server 102.

In some implementations, any and/or all components of the server 102, both hardware and/or software, may interface with each other and/or the interface using an application programming interface (API) 112 and/or a service layer 113. The API 112 may include specifications for routines, data structures, and object classes. The API 112 may be either computer-language independent or dependent and refer to a complete interface, a single function, or even a set of APIs. The service layer 113 provides software services to the example distributed computing system 100. The functionality of the server 102 may be accessible for all service consumers using this service layer. Software services, such as those provided by the service layer 113, provide reusable, defined business functionalities through a defined interface. For example, the interface may be software written in JAVA, C++, or other suitable language providing data in extensible markup language (XML) format or other suitable format.

While illustrated as an integrated component of the server 102 in the example distributed computing system 100, alternative implementations may illustrate the API 112 and/or the service layer 113 as stand-alone components in relation to other components of the example distributed computing system 100. Moreover, any or all parts of the API 112 and/or the service layer 113 may be implemented as child or sub-modules of another software module, enterprise application, or hardware module without departing from the scope of this disclosure.

The server 102 includes an interface 104. Although illustrated as a single interface 104 in FIG. 1A, two or more interfaces 104 may be used according to particular needs, desires, or particular implementations of the example distributed computing system 100. The interface 104 is used by the server 102 for communicating with other systems in a distributed environment—including within the example distributed computing system 100—connected to the network 130; for example, the client 140 as well as other systems communicably coupled to the network 130. Generally, the interface 104 comprises logic encoded in software and/or hardware in a suitable combination and operable to communicate with the network 130. More specifically, the interface 104 may comprise software supporting one or more communication protocols associated with communications such that the network 130 or interface's hardware is operable to communicate physical signals within and outside of the illustrated example distributed computing system 100.

The server 102 includes a processor 105. Although illustrated as a single processor 105 in FIG. 1A, two or more processors may be used according to particular needs, desires, or particular implementations of the example distributed computing system 100. Generally, the processor 105 executes instructions and manipulates data to perform the operations of the server 102. Specifically, the processor 105 executes the functionality required to provide monitoring of financial risks using a quantity ledger.

The server 102 also includes a memory 106 that holds data for the server 102, client 140, and/or other components of the example distributed computing system 100. Although illustrated as a single memory 106 in FIG. 1A, two or more memories may be used according to particular needs, desires, or particular implementations of the example distributed computing system 100. While memory 106 is illustrated as an integral component of the server 102, in alternative implementations, memory 106 can be external to the server 102 and/or the example distributed computing system 100. In some implementations, the memory 106 includes one or more instances of quantity data 114, a quantity ledger 116, and/or a monitor algorithm 118.

The quantity data 114 can be any type of data use to identify, classify, and/or describe instances of business transactions and associated transactions. For example, quantity data 114 could describe a sales order and associated fixed/variably priced obligations, exposure type data (e.g., FX, credit risk, market risk, liquidity risk, operational risk, etc.), goods data, cash data, liquidity data, purchase orders, and the like associated with the sales order. In the example of sales order, the quantity data 114 could include: A flow ID, date, business transaction category, status, flavor, moved object, account alias, contract currency, valuation currency, nominal data, quantity, product, price, and price reference. In some implementations, the status data can include values of “planned,” “fixed,” “reversed,” or the like. In some implementations, quantity data 114 can be grouped. For example, quantity data 114 groupings for a sales order could be variably priced obligations, fixed price obligations, goods data, cash data, and the like.

The quantity data 114 can be generated, stored, and/or converted from/into any suitable format or form, for example, binary, text, numerical, a database file, a flat file, or the like. In some implementations, the quantity data 114 can be wholly or partially part of the quantity ledger 116. In some instances the quantity data 114 can be referenced by and for inclusion into the quantity ledger 116. In some implementations, the quantity data 114 can directly accessed by any suitable component of the example distributed computing system 100, for example the business application 107, JEE 108, TFE 109, and/or EME 110. While the quantity data 114 is illustrated as an integral component of the memory 106, in alternative implementations, quantity data 114 can be external to the memory 106 and/or be separated into both external quantity data 114 and internal quantity data 114 as long as it is accessible using network 130. In some implementations, the quantity data 114 can interface with and/or act as a reference to an internal and/or external storage location and/or provide functionality to retrieve quantity data 114 stored in the external storage location.

Those of skill in the art will appreciate that the provided examples with respect to quantity data 114 are representative only and quantity data 114 could be represented by myriad types of data in multiple ways. Other possible values associated with quantity data 114 and consistent with the disclosure will be apparent to those of skill in the art and/or through analysis of the attached figures. The figures are not intended to be limiting in any way and only serve to illustrate possible quantity data 114 in one implementation. Other quantity data consistent with this disclosure and the described principles is envisioned. FIGS. 2A-2F illustrate example quantity data 114 associated with a sales order.

The quantity ledger 116 can be any type of suitable data structure used to store, group, and process quantity data 114. For example, the quantity ledger 116 could be a spreadsheet, database, flat file, data structure, and/or the like. The quantity ledger 116 can be generated, stored, and/or converted from/into any suitable format or form. In some implementations, multiple quantity ledgers 116 can be used to store associated/non-associated quantity data 114 as journal entries. For example, FIG. 2A illustrates journal entries within a quantity ledger 116 for a sales order. In some implementations, the quantity data 114 can be wholly or partially stored in the quantity ledger 116. In other implementations, the actual quantity data 114 can be wholly or partially independent from the quantity ledger 116 and accessed through references to the quantity data 114. As previously described, in some implementations, the quantity ledger 116 can hold/refer to groups of quantity data 114. For example, quantity data 114 groupings for a sales order stored within a quantity ledger 116 could be variably priced obligations, fixed price obligations, goods data, cash data, and the like as illustrated in FIGS. 2A-2F. Another set of groupings could be associated with a purchase order, a future long transaction, or other suitable transaction consistent with this disclosure.

The quantity ledger 116 can be generated, stored, and/or converted from/into any suitable format or form. In some implementations, the quantity ledger 116 can directly accessed by any suitable component of the example distributed computing system 100, for example the business application 107, JEE 108, TFE 109, and/or EME 110. While the quantity ledger 116 is illustrated as an integral component of the memory 106, in alternative implementations, quantity data 114 can be external to the memory 106 and/or be separated into both an external quantity ledger 116 and an internal quantity ledger 116 as long as it is accessible using network 130. In some implementations, the quantity ledger can act as a reference to another quantity ledger 116, internal and/or external storage location, and/or provide functionality to interface with and/or retrieve quantity data 114 and/or quantity ledgers 116. In some implementations, a separate data structure (not illustrated) can be used as a reference to the data stored within a particular quantity ledger 116.

Those of skill in the art will appreciate that the provided examples with respect to the quantity ledger 116 are representative only and a particular quantity ledger 116 could be represented by myriad types of data in multiple ways. Other possible values associated with a quantity ledger 116 and consistent with the disclosure will be apparent to those of skill in the art and/or through analysis of the attached figures. The figures are not intended to be limiting in any way and only serve to illustrate possible quantity ledgers 116 in one implementation. Other quantity ledgers 116 consistent with this disclosure and the described principles are envisioned.

The exposure monitor algorithm (EMA) 118 includes any parameters, variables, instructions, rules, constraints, and/or the like used to analyze, process, etc. quantity data 114 to log business transaction relate quantity data 114 to a quantity ledger 116, log additional business transactions associated with the logged business transaction quantity data 114 to the quantity ledger 116, and/or determine whether an exposure associated with the quantity data 114 exists. For example, an EMA 118 might specifically be associated with one or more of FX, credit risk, market risk, liquidity risk, operational risk, etc. and be used to monitor quantity data 114 within a quantity ledger 116. Specifically, as illustrated in FIG. 2D, a FX focused EMA 118 could be used to monitor quantity data 114 to detect when an FX exposure exists (e.g., contract currency deviates from the internal reporting—i.e. functional currency), is mitigated, is removed, etc. The EMA 118 can be used by one or more of the business application 107, JEE 108, TFE 109, EME 110, and/or other suitable example distributed system 100 component whether illustrated or not. For example, the TFE 109 could leverage the FX EMA 118 when quantity data 114 for a sales order is received to subsequently generate additional FX related transactions to log to the quantity ledger 116 using, for example, the JEE 108. In some instances, a particular EMA 118 can be created, edited, and/or deleted by an administrator or individual with appropriate permissions. In other implementations, one or more components of the example distributed computing system 100 can dynamically load and/or generate a needed EMA 118 based upon a received, forecasted, edited, and/or deleted business transaction, quantity data 114, or logged journal entry to the quantity ledger 116.

The business application 107 is any type of application that allows the client 140 to request, view, add, edit, delete, and/or consume content on the client 140 obtained from the server 102, external data 150, and/or an additional content provider (not illustrated) in response to a received request from the client 140. A content provider may be, for example, applications and data on a server and/or external services, business applications, business application servers, databases, RSS feeds, document servers, web servers, streaming servers, caching servers, or other suitable content sources.

In some implementations, the business application 107 can also use business application data (not illustrated) including business objects and data, business processes, content provider locations, addresses, storage specifications, content lists, access requirements, or other suitable data. For example, for a database content provider, the business application data may include the server Internet Protocol (IP) address, URL, access permission requirements, data download speed specifications, etc. associated with the database content provider.

Once a particular business application 107 is launched, a client 140 may interactively process a task, event, or other information associated with the server 102. The business application 107 can be any application, program, module, process, or other software that may execute, change, delete, generate, or otherwise manage information associated with a particular client 140. For example, the business application 107 may be a portal application, a business application, and/or other suitable application consistent with this disclosure. The business application 107 can also interface with the JEE 108, TFE 109, EME 110, and/or other suitable component of the example distributed computing system 100 to wholly or partially complete a particular task. For example, the described components could process business processes in a sequential, parallel, and/or other suitable manner.

Additionally, a particular business application 107 may operate in response to and in connection with at least one request received from other business applications 107, including business applications 107 or other components (e.g., software and/or hardware modules) associated with another server 102. In some implementations, the business application 107 can be and/or include a web browser. In some implementations, each business application 107 can represent a network-based application accessed and executed using the network 130 (e.g., through the Internet, or using at least one cloud-based service associated with the business application 107). For example, a portion of a particular business application 107 may be a web service associated with the business application 107 that is remotely called, while another portion of the business application 107 may be an interface object or agent bundled for processing at a remote client 140. Moreover, any or all of a particular business application 107 may be a child or sub-module of another software module or enterprise application (not illustrated) without departing from the scope of this disclosure. Still further, portions of the particular business application 107 may be executed or accessed by a user working directly at the server 102, as well as remotely at a corresponding client 140. In some implementations, the server 102 or any suitable component of server 102 or the example distributed computing system 100 can execute the business application 107.

The journal entry engine (JEE) 109 can be any application, program, module, process, or other software capable of interfacing with the business application 107, TFE 109, and/or EME 110 and to log, edit, and/or delete journal entries of quantity data 114 into one or more quantity ledgers 116. For example, a business transaction can be entered using client 140 into the business application 107. The JEE 108 can received notice of the entered business transaction log appropriate quantity data 114 associated with business transaction to the quantity ledger 116. The TFE 109 can then analyze the entered business transaction and/or the logged quantity data 114 to determine if any associated future business transactions need to also be logged into the quantity ledger 116 (illustrated with the description of FIG. 2A). The EME 110 can also analyze the quantity ledger 116 and associated quantity data 114 to determine whether an exposure exists. In some implementations, the JEE 108 determines which quantity ledger 116 groupings to generate for a particular received business transaction. In some implementations, the JEE 108 also determines edits and/or deletions of particular logged journal entries. The JEE 108 can also be instructed by other components of the server 102 to log, edit, and/or delete journal entries in the quantity ledger 116. The JEE 108 can also interface with the business application 107, TFE 109, EME 110, and/or other suitable component of the example distributed computing system 100 to wholly or partially complete a particular task. In some implementations, the journal entries permitted to be logged to the quantity ledger 116 may be determined by a user permission level, security parameters, etc. In some implementations, the JEE 108 can generate and transmit appropriate notifications to a user or other component of the example distributed computing system. For example, a user may receive a GUI dialog that business transactions have been logged to the quantity ledger 116 based on a received business transaction. In other instances, the JEE 108 can transmit the notice to another component of the example distributed computing system 100 to be handled.

A particular JEE 108 may operate in response to and in connection with at least one request received from other JEE 108, including a JEE 108 associated with another server 102. In some implementations, the JEE 108 can include a web browser. In some implementations, each JEE 108 can represent a network-based application accessed and executed using the network 130 (e.g., through the Internet, or using at least one cloud-based service associated with the JEE 108). For example, a portion of a particular JEE 108 may be a web service associated with the JEE 108 that is remotely called, while another portion of the JEE 108 may be an interface object or agent bundled for processing at a remote client 140. Moreover, any or all of a particular JEE 108 may be a child or sub-module of another software module or enterprise application (not illustrated) without departing from the scope of this disclosure. Still further, all or portions of the particular JEE 108 may be executed or accessed by a user working directly at the server 102, as well as remotely at a corresponding client 140.

The transaction forecast engine (TFE) 109 can be any application, program, module, process, or other software capable of interfacing with the business application 107, JEE 108, and/or EME 110 and to forecast future business transactions associated with a received business transaction. Typically the future business transactions are derived from contractual information which in turn is either explicitly part of a transaction triggering the TFE or which is at least referenced by the transaction. For example, if a sales order is received and logged into the quality ledger 116, the TFE 109 can forecast that future delivery and invoice business transactions need to also be entered into the quality ledger (illustrated with the description of FIG. 2A) to ensure that the zero balance principle is met as described above. In some implementations, the TFE 109 can forecast additional future business transactions for other business transactions that can be affected in some way by the received business transaction. For example, a received sales order could affect a prior sales order and the TFE 109 can forecast appropriate future business transactions related to both the received sales order the prior sales order. The TFE 109 can also forecast future business transactions related to multiple different groupings, for example variably prices obligations, fixed price obligations, and the like. In some implementations, the TFE transmits data to the business application 107, JEE 108, and/or EME 110. The TFE 109 can receive business transaction and/or quantity data 114 from the business application 107, JEE 108, and/or the EME 110 which can start one or more forecast operations. In some implementations, the TFE monitors the quantity data 114 and/or quantity ledger 116 in real-time. The TFE 109 can also be instructed by other components of the server 102 to perform a transaction forecast operation based upon received data or other suitable reason. The TFE 109 can also interface with the business application 107, JEE 108, EME 110, and/or other suitable component of the example distributed computing system 100 to wholly or partially complete a particular task. In some implementations, the permitted forecasted business transactions may be determined by a user permission level, security parameters, etc. In some implementations, the TFE 109 can generate and transmit appropriate notifications to a user or other component of the example distributed computing system. For example, a user may receive a GUI dialog that additional future business transactions have been generated and requesting permission to insert the business transactions into the quantity ledger 116. In other instances, the TFE 109 can transmit the notice to another component of the example distributed computing system 100 to be appropriately handled.

A particular TFE 109 may operate in response to and in connection with at least one request received from other TFE 109, including a TFE 109 associated with another server 102. In some implementations, the TFE 109 can include a web browser. In some implementations, each TFE 109 can represent a network-based application accessed and executed using the network 130 (e.g., through the Internet, or using at least one cloud-based service associated with the TFE 109). For example, a portion of a particular TFE 109 may be a web service associated with the TFE 109 that is remotely called, while another portion of the TFE 109 may be an interface object or agent bundled for processing at a remote client 140. Moreover, any or all of a particular TFE 109 may be a child or sub-module of another software module or enterprise application (not illustrated) without departing from the scope of this disclosure. Still further, all or portions of the particular TFE 109 may be executed or accessed by a user working directly at the server 102, as well as remotely at a corresponding client 140.

The exposure monitor engine (EME) 110 can be any application, program, module, process, or other software capable of interfacing with the business application 107, JEE 108, and/or TFE 109 and to monitor the quantity data 114 and/or the quantity ledger 116 for exposures. In some implementations, this monitoring is performed in real-time. In some implementations, the EME 110 is triggered by the actions of other components of the server 102. For example, once the JEE 108 has logged quantity data 114 as journal entries to the quantity journal 116, it can notify the EME 110 to analyze the data for exposures.

An exposure monitor can be any type of analytical software capable of restricting quantity flows selected to an appropriate set of flows and then aggregating associated amounts or quantities. Financial risks originating from any supplying source system/program (e.g., CRM, SRM, and the like) and subsequently forecasted transactions can be evaluated in the same manner. In some implementations, a query service can take blend in market data, for example FX rates, on the fly.

The EME 110 also leverages one or more EMAs 118 to perform its analysis. For example, the EME 110 can monitor for variable price obligations, fixed price obligations, FX, goods, cash, liquidity, etc. using the one or more EMAs 118. In some implementations, the TFE 109 can inform the EME 110 which EMAs 118 need to be loaded in order to monitor the quantity ledger 116. The EME 110 can also interface with the business application 107, JEE 108, EME 110, and/or other suitable component of the example distributed computing system 100 to wholly or partially complete a particular task. In some implementations, the EMAs 118 accessed and used by the EME 110 may be determined by a user permission level, security parameters, etc. In some implementations, the EME 110 can generate and transmit appropriate notifications to a user or other component of the example distributed computing system. For example, a user may receive a GUI dialog that an exposure has been detected and needs to be managed. In other instances, the EME 110 can transmit the notice to another component of the example distributed computing system 100 to be handled.

In some implementations, the EME 110 also determines whether aggregated journal entry data is actionable. For example, if two journal entries in a quantity ledger 116 indicated that a party was owed $3,000 USD but had already received $700 USD, the aggregation of these two would indicate that they were currently owed $2,300 USD. The EME 110 accesses internal and/or external rules (not illustrated) that indicate whether an action should be taken to mitigate a determined risk due to the aggregated data. For example, if the party was owed $2,300 USD in ninety days, but an internal/external rule indicates that anything over 45 days is unacceptably risky for a specific type of exposure (e.g., FX), then an action can be taken to mitigate the risk of the FX.

A particular EME 110 may operate in response to and in connection with at least one request received from other EME 110, including an EME 110 associated with another server 102. In some implementations, the EME 110 can include a web browser. In some implementations, each EME 110 can represent a network-based application accessed and executed using the network 130 (e.g., through the Internet, or using at least one cloud-based service associated with the EME 110). For example, a portion of a particular EME 110 may be a web service associated with the EME 110 that is remotely called, while another portion of the EME 110 may be an interface object or agent bundled for processing at a remote client 140. Moreover, any or all of a particular EME 110 may be a child or sub-module of another software module or enterprise application (not illustrated) without departing from the scope of this disclosure. Still further, all or portions of the particular EME 110 may be executed or accessed by a user working directly at the server 102, as well as remotely at a corresponding client 140.

The client 140 may be any computing device operable to connect to or communicate with at least the server 102 and/or the external data 150 using the network 130. In general, the client 140 comprises an electronic computing device operable to receive, transmit, process, and store any appropriate data associated with the example distributed computing system 100. The client includes a processor 144, a client application 146, a memory 148, and/or an interface 149.

The client application 146 is any type of application that allows the client 140 to navigate to/from, request, view, edit, delete, and or manipulate content on the client 140. In some implementations, the client application 146 can be and/or include a web browser. In some implementations, the client-application 146 can use parameters, metadata, and other information received at launch to access a particular set of data from the server 102 and/or the external data 150. Once a particular client application 146 is launched, a user may interactively process a task, event, or other information associated with the server 102 and/or the external data 150. Further, although illustrated as a single client application 146, the client application 146 may be implemented as multiple client applications in the client 140. In some implementations, the client application 146 may act as a GUI interface for the business application 107 and/or other components of server 102 and/or other components of the example distributed computing system 100, for example the external data 150.

The interface 149 is used by the client 140 for communicating with other computing systems in a distributed computing system environment, including within the example distributed computing system 100, using network 130. For example, the client 140 uses the interface to communicate with the server 102 and/or the external data 150 as well as other systems (not illustrated) that can be communicably coupled to the network 130. The interface 149 may be consistent with the above-described interface 104 of the enterprise server 102 or other interfaces within the example distributed computing system 100. The processor 144 may be consistent with the above-described processor 105 of the server 102 or other processors within the example distributed computing system 100. Specifically, the processor 144 executes instructions and manipulates data to perform the operations of the client 140, including the functionality required to send requests to the server 102 and/or external data 150 and to receive and process responses from the server 102 and/or the external data 150. The memory 148 typically stores objects and/or data associated with the purposes of the client 140 but may also be consistent with the above-described memory 106 of the server 102 or other memories within the example distributed computing system 100, for example external data 150, but storing, for example, quantity data 114, a quantity ledger 116, and/or a monitor algorithm 118 similar to that stored in memory 106 of server 102.

Further, the illustrated client 140 includes a GUI 142. The GUI 142 interfaces with at least a portion of the example distributed computing system 100 for any suitable purpose, including generating a visual representation of a web browser. The GUI 142 may be used to view and navigate various web pages located both internally and externally to the server 102, view data associated with the server 102 and/or external data 150, or any other suitable purpose. In particular, the GUI 142 may be used in conjunction with content from server 102 and/or external data 150 to monitor financial risks using a quantity ledger.

There may be any number of clients 140 associated with, or external to, the example distributed computing system 100. For example, while the illustrated example distributed computing system 100 includes one client 140 communicably coupled to the server 102 and external data 150 using network 130, alternative implementations of the example distributed computing system 100 may include any number of clients 140 suitable to the purposes of the example distributed computing system 100. Additionally, there may also be one or more additional clients 140 external to the illustrated portion of the example distributed computing system 100 that are capable of interacting with the example distributed computing system 100 using the network 130. Further, the term “client” and “user” may be used interchangeably as appropriate without departing from the scope of this disclosure. Moreover, while the client 140 is described in terms of being used by a single user, this disclosure contemplates that many users may use one computer, or that one user may use multiple computers.

The illustrated client 140 is intended to encompass any computing device such as a desktop computer, laptop/notebook computer, wireless data port, smart phone, personal data assistant (PDA), tablet computing device, one or more processors within these devices, or any other suitable processing device. For example, the client 140 may comprise a computer that includes an input device, such as a keypad, touch screen, or other device that can accept user information, and an output device that conveys information associated with the operation of the server 102 or the client 140 itself, including digital data, visual and/or audio information, or a GUI 142, as shown with respect to the client 140.

Turning to FIG. 1B, FIG. 1B is a block diagram illustrating additional components of a server for monitoring financial risks using a quantity ledger according to one implementation.

As illustrated, one or more business applications 107, for example CRM Software, SRM Software, and/or Treasury Software deliver data to a quantity ledger (QL) interface 122. The QL interface 122 defines a format in which the data is to be provided. In some implementations, the received data is formatted as a quantity business transaction (QBT) 124. Once properly formatted data is received, the QL interface 122 triggers further processing of this data.

The QL interface 122 forwards the data (QBTs 124) to a central process controlling component, a quantity ledger (QL) distributor 126. The QL distributor 126 stores incoming QBTs 124 to a quantity ledger 116 (here illustrated as a database). In some implementations, the QL distributor 126 can also coordinate components for forecasting logic (e.g., the TFE 109). In some implementations, The TFE 109 can actually consist of a set of specialized forecast engines 120 (illustrated as four example forecast engines 120a-120d) to handle certain quantity flows within a QBT. For example a sales order forecast engine 120a can react to QBT 124 flows referencing sales orders and create and/or adjust a subsequent QBT 124, which might be an invoice. Analogously, an invoice forecast 120b engine can react to QBT 124 flows referencing invoices and create (derive) new QBTs 124, for example outgoing payments or expected incoming cheques. Similarly, a tax forecasting engine 120c could react to tax payables and receivables on invoices and forecast a tax payment. In some implementations, the TFE 109 can be easily enhanced by adding additional/different featured forecast engines 120 which handle differentiated quantity flows. Inversely the TFE 109 can be simplified by reducing a number of forecast engines 120; producing less detailed information about future QBTs 124. Fewer forecast engines 120 would typically result in an overall performance gain at the cost of forecast precision.

In some implementations, forecast engines 120a-120d can return derived QBTs 124 to the QL distributor 126. The QL distributor 126 stores “derived” QBTs 124 in the quantity ledger 116 and passes to one or more forecast engines 120 for subsequent processing. In this way, the result of one forecast engine 120 can act as a trigger for another forecast engine 120. This behavior typically ends when a “chain” of QBTs 124 reaches a “stock” flavor for the product as well as for the monetary chain.

In order to offer a fast and stable means of evaluating the quantity ledger 116, the software offers a query service 128. The query service 128 internally optimizes typical requests for data retrieval against the capability of a database management system associated with the illustrated quantity ledger 116. Most retrieval requests will request aggregated data to allow processing within acceptable response times.

FIGS. 2A-2F illustrate journal entries in a quantity ledger resulting from the creation of a sales order according to one implementation. Turning to FIG. 2A, a U.S. customer at 202 orders 10,000 kg of chocolate on 01.02.13 at a price of 0.30 USD/kg. The sales order (flows 1.1 and 1.2) trigger a series of future transactions as determined by the TFE 109 based upon the sales order. The future transactions are indicated as delivery 204 scheduled for 01.08.13 and invoicing 206 scheduled for 01.09.13. 204 and 206 are indicated as in status “planned,” meaning they are not yet actual transactions and thus can change. Note that the sales order 202, i.e. the transaction representing the contract agreement, is in a “fixed” status and cannot change as it is a contractual agreement on 01.02.13. The delivery 204 and invoicing 206 can be seen as similar to transfer postings, representing the transition from an obligation to deliver goods to a change in stock.

Turning to FIG. 2B, all flows with variable prices, i.e., flows with an empty price column, are selected. As of 01.02.13 there are none to select. Note that in this implementation, the monitors have additional quantity data columns, for example, contract value in contract currency (CC) and valuation currency (VC) as well as the internal value.

Turning to FIG. 2C, all flows with fixed price obligations are selected. Calculation of contract values is trivial, because the prices are fixed. For example, based upon a price of 0.30 USD/kg for 10,000 kg and an exchange rate of 0.82 (EUR/USD) on the invoice date, for flow 3.1 a contract value (CC) of “+3000” and a contract value (VC) of “+2460” is determined. The contract value (VC) is determined by using the exchange rate data in Table 5A, row 502 for horizon date 01.09.13 of 0.82. Multiplying 3000×0.82=2460. Other values are similarly determined and added to the quantity ledger in appropriate positions within each journal entry. Also note that flow 2.1 has a price value of 0.20 EUR/kg because in some implementations a controller (e.g., the JEE 108, TFE 109, and/or EME 110) can introduce a value as an “arbitrary” internal price to make sales easy to calculate and shift a burden of varying prices completely to the purchasing process.

Turning to FIG. 2D, an EME 110/EMA 118 selects all non-stock cash flows which have a CC different from the VC, i.e., the local currency. Even without attributing values, the monitor shows that an FX exposure starts on 01.02.13 and ends on 01.09.13. The values are calculated based on market data as of 01.02.13.

Turning to FIG. 2E, all goods (chocolate) related flows are selected. This selection allows an inventory of chocolate to be monitored.

Turning to FIG. 2F, all cash related flows are selected. These are the basis for a cash management analysis. Note that this can also we considered an inventory of cash similar to chocolate as in FIG. 2E.

FIGS. 3A-3F illustrate journal entries in a quantity ledger resulting from the creation of a purchase order according to one implementation.

Turning to FIG. 3A, on 05.02.13 a company orders cocoa from some producing plantation. While for the prior example sales order (FIGS. 2A-2F) only 5,000 kg of cocoa are necessary to produce the ordered 10,000 kg of chocolate, the company orders 5,700 kg to be on the safe side and to have extra if needed. The price is the market price of exchange EX1 302 at the 30.05.13, at which the electronic invoice is scheduled as well. Delivery of the cocoa is scheduled for 16.05.13.

Similar to the sales order illustrated in FIGS. 2A-2F, the purchase order (flows 4.1 and 4.2) at 304 result in two subsequent transactions 306 and 308 determined by TFE 109. However, the amount to be invoiced is unclear (unlike FIG. 2A) because just a reference to the exchange (EX1) is given at 302. Note that the date of the price fixing must coincide with the invoice date at 308 in this example although, in general, price fixing is normally a separate transaction from the invoice.

Turning to FIG. 3B, a commodity price risk is detected by EME 110 since there is a variably priced position starting on 05.02.13 and ending 30.05.13. The values in CC and VC are calculated using market data indicated in FIG. 5B at 504 as of 05.02.13 for a horizon of 30.05.13. Here 5700 kg×0.11=627 USD. Also, the price in EUR is determined by converting the 627 USD value to EUR using FIG. 5A at 506. The exchange rate value of 0.81 is the first value to encompass the 05.02.13 start date and the 30.05.13 end date (30.05.13<=01.09.13). Therefore, 627 USD×0.81=507.87 EUR.

Turning to FIG. 3C, the fixed price obligation monitor illustrates that every new flow connected to the purchase order is accounted for in the quality ledger.

Turning to FIG. 3D, the FX monitor illustrates flows according to the same selection criteria as FIG. 2D. However, FIG. 3D illustrates that the FX risk reduces naturally between 05.02.13 and 30.05.13. The exact amount of FX exposure is still unclear, because flow 6.1 is variable (note the price reference 310 to EX1). Taking appropriate market data into account from FIG. 5A at 506, the monitor gives a reasonable estimate of the FX exposure.

Turning to FIG. 3E, the physical goods monitor illustrates two different positions (chocolate and cocoa).

Turning to FIG. 3F, the cash monitor is identical to the FX monitor (FIG. 3D) because all payments are made in U.S. dollars.

FIGS. 4A-4D illustrate journal entries in a quantity ledger resulting from the purchase of a future (long) according to one implementation. Turning to FIG. 4A, a company purchases the cocoa future (long) on 06.02.13 to hedge the variable contract price of the purchase. One future 402 (flows 7.1 and 7.2) has a size of 5,000 kg and is traded at exchange EX1 in USD and in this example, only futures for 17.05.13 in May are available. Therefore, the price of 5,000 kg of cocoa will be calculated at 0.12 USD/kg as shown in FIG. 5B at 508.

In addition, the future contract 402 (flows 7.1 and 7.2) creates obligations similar to the purchase order as illustrated in FIG. 3A. Assuming in the example that the future will be cash settled at its maturity, the difference between the agreed fixed price 0.12 USD/kg and the market price will be exchanged as cash (flow 8.3 at 404). Therefore the reference to the exchange EX1 at 406 as well as the fixed price 408 of 0.12 kg are given. The flow is considered a variably priced one.

Turning to FIG. 4B, since the cocoa future (long) does not exactly match the purchase of FIGS. 3A-3F order, the quantity of variably priced cocoa never drops to zero. The figure illustrates the time dependency of the commodity price exposure starting at 05.02.13 with −5,700 kg, dropping −700 kg and increasing for a short period of time to 5,700 kg before vanishing.

Turning to 4C, the fixed price obligation monitor illustrates every flow connected to the sales order, purchase order, and cocoa future (long) is accounted for in the quality ledger.

Turning to FIG. 4D, the FX monitor is illustrated with much represented activity. The cocoa future (long) contributes two flows to the value as of the future contract date 410 (flows 8.1 and 8.2). The main effect of the flows is that the USD price of cocoa does not change much as the market price changes for cocoa. The dependence on the exchange rate 412 has not significantly changed. All values are calculated using appropriate market data as of 06.02.13.

FIG. 6 is a flow chart illustrating a method 600 for monitoring financial risks using a quantity ledger according to one implementation. For clarity of presentation, the description that follows generally describes method 600 in the context of FIGS. 1, 2A-2F, 3A-3F, 4A-4D, and 5A-5B. However, it will be understood that method 600 may be performed, for example, by any other suitable system, environment, software, and hardware, or a combination of systems, environments, software, and hardware as appropriate.

At 602, a contract is received. A contract can be any type of business transaction. In some implementations, the contract is received by the business application and/or JEE from a client device. From 602, method 600 proceeds to 604.

At 604, at least one transaction associated with the received contract is identified by parsing the received contract. In the examples provided in FIGS. 2A, 3A, and 4A, the contract is a sales order, purchase order, and future (long), respectively. In some implementations, there can be multiple transactions per contract. In some implementations, the associated transactions can be identified sequentially and/or in parallel. In some implementations, a transaction is identified by the business application, JEE, and/or the TFE. From 604, method 600 proceeds to 606.

At 606, forecasted future transactions associated with the identified transaction are derived. For example, with a sales order, a scheduled delivery and invoicing can be derived as future transactions. In some implementations, the forecasted future transactions can be automatically derived by one or more TFEs operating individually, jointly, sequentially, in parallel, or in any appropriate combination. From 606, method 600 proceeds to 608.

At 608, the derived forecasted future transactions are logged into a quantity ledger by the JEE. In some implementations, the derived forecasted future transactions can be logged into one or more quantity ledgers as journal entry data. The journal entry data can be logged in any format, order, orientation and/or grouping consistent with this disclosure. In some implementations, a user can be prompted to allow the derived expected future transactions to be logged into a quantity ledger (e.g., presented with an option as to format, location, and the like.) From 608, method 600 proceeds to 610.

At 610, Select quantity ledger data based on some determined value/criteria as to what is considered a risk. For example, for a purchase order with a price referring to an exchange rate on a specific date, unknown prices or prices subject to an exchange rate fluctuation can be determined to be a risk. FIG. 3B illustrates variably prices obligations that could be selected. From 610, method 600 proceeds to 612.

At 612, the selected quantity ledger quantity/transaction data in journal entries is aggregated. From 612, method 600 proceeds to 614.

At 614, a rule set is applied to the aggregated data to determine if an unacceptable exposure risk exists where an action should be performed to mitigate the risk. From 614, method 600 proceeds to 616.

At 616, a determination is made whether an exposure mitigating action should be performed. If at 616 it is determined that an exposure mitigating action should be performed, method 600 proceeds to 618. If, however, at 616 it is determined that an exposure mitigation action should not be performed, method 600 proceeds back to 610.

At 618, an exposure mitigating action is performed. For example, a future (long) could be purchased to mitigate a FX risk or other suitable exposure mitigating action could be taken. From 618, method 600 proceeds to 610.

In some implementations, various steps of method 600 can be run in parallel, in combination, in loops, or in any order. For example, the identification of a contract transaction 604 may result in simultaneous identification of multiple contract transactions. In this instance, the identification can spawn multiple copies (or portions) of method 600, multiple threads, and/or other suitable method(s) to handle each identification in parallel or in any manner suitable to handle the multiple actions in an efficient manner.

FIGS. 1, 2A-2F, 3A-3F, 4A-4D, and 5A-5B illustrate and describe various aspects of computer-implemented methods, computer-readable media, and computer systems for monitoring financial risks using a quantity ledger. While the disclosure discusses the processes in terms of financial risks, as will be apparent to one of skill in the art, the described computer-implemented methods, computer-readable media, and computer systems can also be applied to any type of data with associated risk-type values that can be analyzed, reported, and/or leveraged to increase efficiency, perform simulations, perform stress testing, or any other applicable action consistent with this disclosure. The description in the disclosure of the computer-implemented methods, computer-readable media, and computer systems in terms of financial risk is not meant to limit the applicability of the disclosure in any way.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example, a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDFLOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically-erasable programmable read-only memory (EEPROM), and flash memory devices; magnetic disks, e.g., internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method comprising:
receiving a contract, wherein the contract includes at least one transaction;
parsing the contact to identify the at least one transaction;
deriving, by operation of a computer, at least one associated future transaction for the at least one transaction;
logging the derived at least one associated future transaction to a quantity ledger;
aggregating, by operation of a computer, the logged quantity ledger data to determine the presence of an exposure; and
applying at least one rule to determine if an exposure mitigating action should be performed based upon the aggregated logged quantity ledger data.

2. The method of claim 1, wherein the at least one associated future transaction is derived in parallel for two or more identified transactions.

3. The method of claim 1, wherein the logged data is stored in the quantity ledger as at least one quantity flow.

4. The method of claim 3, wherein the quantity ledger is divided into at least one quantity position, each quantity position representing a set of selection criteria associated with a valuation purpose for at least one quantity flow.

5. The method of claim 3, wherein an exposure is defined as a quantity flow with a contract value deviating from an internal value.

6. The method of claim 3, further comprising selecting flows in the quantity ledger based upon at least one quantity position.

7. The method of claim 1, wherein aggregated quantity flows must balance to zero.

8. A non-transitory, computer-readable medium storing computer-readable instructions executable by a computer to:
receive a contract, wherein the contract includes at least one transaction;
parse the contact to identify the at least one transaction;
derive at least one associated future transaction for the at least one transaction;
log the derived at least one associated future transaction to a quantity ledger;
aggregate the logged quantity ledger data to determine the presence of an exposure; and
apply at least one rule to determine if an exposure mitigating action should be performed based upon the aggregated logged quantity ledger data.

9. The medium of claim 8, wherein the at least one associated future transaction is derived in parallel for two or more identified transactions.

10. The medium of claim 8, wherein the logged data is stored in the quantity ledger as at least one quantity flow.

11. The medium of claim 10, wherein the quantity ledger is divided into at least one quantity position, each quantity position representing a set of selection criteria associated with a valuation purpose for at least one quantity flow.

12. The medium of claim 10, wherein an exposure is defined as a quantity flow with a contract value deviating from an internal value.

13. The medium of claim 10, further comprising instructions to select flows in the quantity ledger based upon at least one quantity position.

14. The medium of claim 8, wherein aggregated quantity flows must balance to zero.

15. A computer system, comprising:
a memory configured to hold a contract; and
at least one computer interoperably coupled to the memory and configured to:
receive the contract, wherein the contract includes at least one transaction;
parse the contact to identify the at least one transaction;
derive at least one associated future transaction for the at least one transaction;
log the derived at least one associated future transaction to a quantity ledger;
aggregate the logged quantity ledger data to determine the presence of an exposure; and
apply at least one rule to determine if an exposure mitigating action should be performed based upon the aggregated logged quantity ledger data.

16. The system of claim 15, wherein the at least one associated future transaction is derived in parallel for two or more identified transactions.

17. The system of claim 15, wherein the logged data is stored in the quantity ledger as at least one quantity flow.

18. The system of claim 17, wherein the quantity ledger is divided into at least one quantity position, each quantity position representing a set of selection criteria associated with a valuation purpose for at least one quantity flow.

19. The system of claim 17, wherein an exposure is defined as a quantity flow with a contract value deviating from an internal value.

20. The system of claim 17, further configured to select flows in the quantity ledger based upon at least one quantity position.

21. The system of claim 15, wherein aggregated quantity flows must balance to zero.

22. A computer-implemented method comprising:
receiving a contract, wherein the contract includes at least one transaction;
parsing the contact to identify the at least one transaction;
deriving, by operation of a computer, at least one associated future transaction for the at least one transaction, wherein the at least one associated future transaction is derived in parallel for two or more identified transactions;
logging the derived at least one associated future transaction to a quantity ledger, wherein the logged data is stored in the quantity ledger as at least one quantity flow, and wherein the quantity ledger is divided into at least one quantity position, each quantity position representing a set of selection criteria associated with a valuation purpose for at least one quantity flow;
selecting flows in the quantity ledger based upon at least one quantity position;
aggregating, by operation of a computer, the logged quantity ledger data to determine the presence of an exposure, wherein an exposure is defined as a quantity flow with a contract value deviating from an internal value, and wherein aggregated quantity flows must balance to zero; and
applying at least one rule to determine if an exposure mitigating action should be performed based upon the aggregated logged quantity ledger data.
